(19) United States
(12) Patent Application Publication
(10) Pub. No.: US 2007/0233430 A1
(43) Pub. Date: Oct. 4, 2007

(54) USB-MSD Based Real Time Data Logger, Automation and Tuning System

(75) Inventor: Gurinder Singh, Chandler, AZ (US)

Correspondence Address: BAKER BOTTS, LLP, 910 LOUISIANA, HOUSTON, TX, 77002-4995, US

(73) Assignee: MICROCHIP TECHNOLOGY INCORPORATED, CHANDLER, AZ (US)

(21) Appl. No.: 11/550,034

(22) Filed: Oct. 17, 2006

Related U.S. Application Data
(60) Provisional application No. 60/788,967, filed on Apr. 4, 2006.

(51) Int. Cl. G06F 17/40

(52) U.S. Cl. 702/187; 702/127; 702/189

(57) ABSTRACT

A Universal Serial Bus—Mass Storage Device (USB-MSD) based data logger may store data from sensors onto a Secure Digital (SD) card, these stored files may be analyzed on a personal computer (PC) using standard PC applications, then based on the logged data a new file for tuning may be created and transferred to a microcontroller using a desired standard protocol, e.g., MSD protocol. This file may then be decoded by the microcontroller and appropriate peripherals may be operated based on the file data.

### RELATED PATENT APPLICATION

This application claims priority to commonly owned U.S. Provisional Patent Application Ser. No. 60/788,967; filed Apr. 4, 2006; entitled “USB-MSD Based Real Time Data Logger, Tuning and Automation System” by Gurinder Singh, and is hereby incorporated by reference herein for all purposes.

### TECHNICAL FIELD

The present disclosure relates to real time data logging, system automation and tuning thereof, and more particularly, to a USB-MSD based real time data logging, automation and tuning system.

### BACKGROUND

Industrial and commercial data logging, automation control, power management, medical devices, security systems, military ordinance and automotive applications may have complex and proprietary hardware interfaces and software program control. Thus, cost effectively implementing some form of coherent and integrated real time data logging, system automation and tuning thereof has not been practical.

For example, in industrial production environments, machines such as lathes, compression-molding presses, ultraviolet curing stations, sanding stations, sandblasting stations, electric ovens, painting stations and testing platforms run around-the-clock. The result is often sky-high energy bills and unforeseen power outages that may be due to rolling blackouts and/or overloaded distribution circuits.

### SUMMARY

Therefore what is desired is a low cost, and simple to program real time data logging, automation and tuning system using standard, readily available components and easily interfaced to a standard personal computer (PC) and/or a personal digital assistant (PDA) over a standard Universal Serial Bus (USB).

According to teachings of this disclosure, a Universal Serial Bus—Mass Storage Device (USB-MSD) based data logger may store data from sensors onto a Secure Digital (SD) card, these stored files may be analyzed on a personal computer (PC) using standard PC applications, then based on the logged data a new file for tuning may be created and transferred to the microcontroller using a desired standard protocol, e.g., MSD protocol. This file may then be decoded by the microcontroller and appropriate peripherals may be operated based on the file data.

According to a specific example embodiment of this disclosure, a system for industrial real time data logging, automation and tuning may comprise: a microcontroller having input-output, a file coding and decoding module, a Universal Serial Bus (USB) port, and a non-volatile memory interface; an industrial device; power control coupled to a first power source and the industrial device, wherein the power control is coupled to the microcontroller input-output and controlled by the microcontroller; sensors coupled to the industrial device and the microcontroller input-output, wherein the sensors supply information about the industrial device to the microcontroller; a non-volatile memory coupled to the SPI Bus of the microcontroller; and a second power source in case of stand alone operation of the microcontroller and non-volatile memory; wherein a real time data logging, automation and tuning program is stored in the non-volatile memory and controls the microcontroller when the microcontroller is monitoring and controlling operation of the industrial device.

According to another specific example embodiment of this disclosure, a system for medical real time data logging, automation and tuning may comprise: a microcontroller having input-output, a file coding and decoding module, a Universal Serial Bus (USB) port, and a non-volatile memory interface; a medical device; power control coupled to a first power source and the medical device, wherein the power control is coupled to the microcontroller input-output and controlled by the microcontroller; sensors coupled to the medical device and the microcontroller input-output, wherein the sensors supply information about the medical device to the microcontroller; a non-volatile memory coupled to the non-volatile memory interface of the microcontroller; and a second power source for powering the microcontroller and non-volatile memory; wherein a real time data logging, automation and tuning program is stored in the non-volatile memory and controls the microcontroller when the microcontroller is monitoring and controlling operation of the medical device.

According to yet another specific example embodiment of this disclosure, a system for security real time data logging, automation and tuning, said system comprising: a microcontroller having input-output, a file coding and decoding module, a Universal Serial Bus (USB) port, and a non-volatile memory interface; at least one security device coupled to the microcontroller input-output and controlled by the microcontroller; security sensors coupled to the microcontroller input-output, wherein the sensors supply security information to the microcontroller; a non-volatile memory coupled to the non-volatile memory interface of the microcontroller; and a power source for powering the microcontroller and non-volatile memory; wherein a real time data logging, automation and tuning program is stored in the non-volatile memory and controls the microcontroller when the microcontroller is monitoring and controlling operation of the security device.

According to still another specific example embodiment of this disclosure, a system for missile real time data logging, automation and tuning may comprise: a microcontroller having input-output, a file coding and decoding module, a Universal Serial Bus (USB) port, and a non-volatile memory interface; missile position control coupled to the microcontroller input-output and controlled by the microcontroller; a global position satellite (GPS) receiver coupled to the microcontroller input-output, wherein the GPS receiver supplies information about a position of the GPS receiver to the microcontroller; a non-volatile memory coupled to the non-volatile memory interface of the microcontroller; and a power source for powering the microcontroller and non-volatile memory; wherein a real time data logging, automation and tuning program is stored in the non-volatile memory and controls the microcontroller when the microcontroller is monitoring and controlling operation of the missile position control.

According to another specific example embodiment of this disclosure, a system for vehicle real time data logging, automation and tuning may comprise: a microcontroller having input-output, a file coding and decoding module, a Universal Serial Bus (USB) port, and a non-volatile memory interface; vehicle drive controls coupled to the microcontroller input-output and controlled by the microcontroller, the vehicle controls adapted for controlling a vehicle; a global position satellite (GPS) receiver coupled to the microcontroller input-output, wherein the GPS receiver supplies information about a position of the GPS receiver to the microcontroller; vehicle sensors coupled to the microcontroller input-output, wherein the vehicle sensors supply information about operation of the vehicle to the microcontroller; a non-volatile memory coupled to the non-volatile memory interface of the microcontroller; and a power source for powering the microcontroller and non-volatile memory; wherein a real time data logging, automation and tuning program is stored in the non-volatile memory and controls the microcontroller when the microcontroller is monitoring and controlling operation of the vehicle drive controls.

### BRIEF DESCRIPTION OF THE DRAWINGS

A more complete understanding of the present disclosure thereof may be acquired by referring to the following description taken in conjunction with the accompanying drawings wherein:

FIG. 1 illustrates a schematic block diagram of a personal computer and microcontroller having input-output and memory storage, and adapted for use as a USB-MSD based real time data logger, automation and tuning system, according to teachings of this disclosure;

FIG. 2 illustrates a schematic block diagram of the personal computer and microcontroller of FIG. 1 having input-output and memory storage, and adapted for use as a USB-MSD based real time data logger, automation and tuning system for industrial applications, according to a specific example embodiment of this disclosure;

FIG. 3 illustrates a schematic block diagram of the personal computer and microcontroller of FIG. 1 having input-output and memory storage, and adapted for use as a USB-MSD based real time data logger, automation and tuning system for medical applications, according to another specific example embodiment of this disclosure;

FIG. 4 illustrates a schematic block diagram of the personal computer and microcontroller of FIG. 1 having input-output and memory storage, and adapted for use as a USB-MSD based real time data logger, automation and tuning system for security applications, according to yet another specific example embodiment of this disclosure;

FIG. 5 illustrates a schematic block diagram of the personal computer and microcontroller of FIG. 1 having input-output and memory storage, and adapted for use as a USB-MSD based real time data logger, automation and tuning system for missile position control applications, according to still another specific example embodiment of this disclosure; and

FIG. 6 illustrates a schematic block diagram of the personal computer and microcontroller of FIG. 1 having input-output and memory storage, and adapted for use as a USB-MSD based real time data logger, automation and tuning system for vehicle control applications, according to another specific example embodiment of this disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

Referring now to the drawings, the details of specific example embodiments are schematically illustrated. Like elements in the drawings will be represented by like numbers, and similar elements will be represented by like numbers with a different lower case letter suffix.

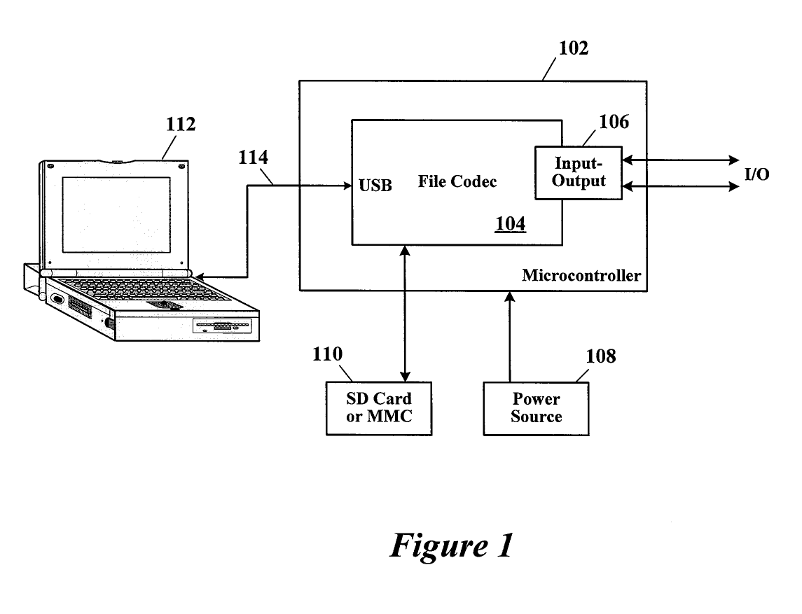

Referring to FIG. 1, depicted is a schematic block diagram of a personal computer and microcontroller having input-output and memory storage, and adapted for use as a USB-MSD based real time data logger, automation and tuning system, according to teachings of this disclosure. A microcontroller 102 may comprise a file codec (code-decode) 104 having a Universal Serial Bus (USB) port, and input-output (I/O) 106. A personal computer (PC) or personal digital assistant (PDA) (hereinafter PC) 112 may be coupled to the USB port of the microcontroller 102 over a Universal Serial Bus (USB) 114. The file codec 104 may be adapted for coupling to a Secure Digital (SD) card or Multimedia card (MMC) 110 (shown), or other non-volatile mass storage device. The file codec 104 may act as a stand-alone Mass Storage Device (MSD) and/or as a Secure Digital/Multimedia Card (SD/MMC) reader/writer interface for writing and reading in standard data storage formats e.g., MSD protocol, Serial Peripheral Interface (SPI) Bus mode, SD Bus mode, etc. The microcontroller 102 may be powered from a power source 108, e.g., battery, power supply, solar cells, fuel cell, etc.

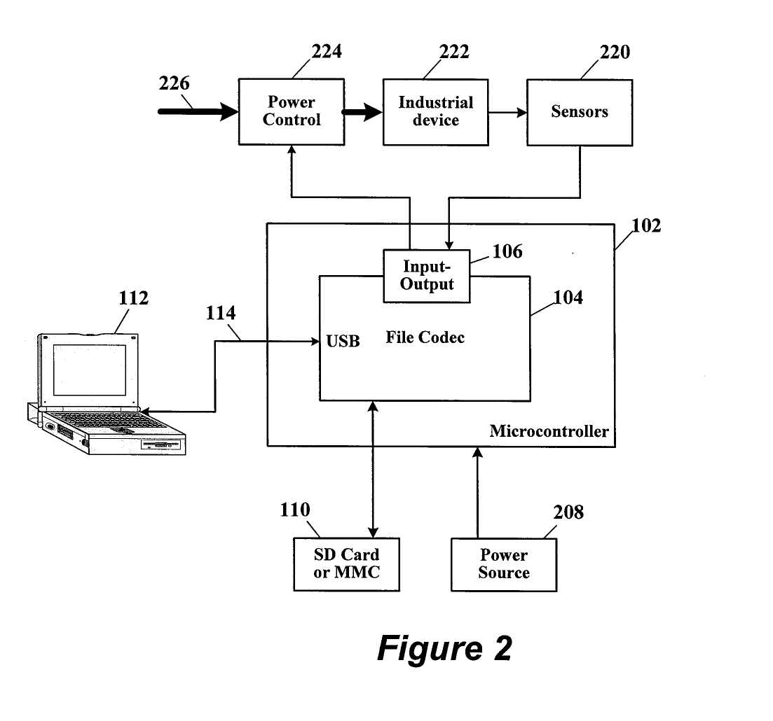

Referring to FIG. 2, depicted is a schematic block diagram of the personal computer and microcontroller of FIG. 1 having input-output and memory storage, and adapted for use as a USB-MSD based real time data logger, automation and tuning system for industrial applications, according to a specific example embodiment of this disclosure. The power source 208 may be a battery, power supply, solar cells, fuel cell, etc. A power control 224, e.g., silicon controlled rectifiers (SCRs), triacs, power relays, etc., may be used to control power from a power source 226 to be supplied to an industrial device 222. Operation of the industrial device 222 may be monitored with sensors 220. The input-output 106 of the microcontroller 102 may be used to control the power control 224 and receive information about industrial device 222 from the sensors 220. A time of day clock (not shown) may be used in combination with a load shedding schedule that may be stored in the SD card or MMC 110. Operational profiles for the industrial device 222 may also be stored in the SD card or MMC 110. Programming of the microcontroller 102 and/or data transfer between the SD card or MMC 110 and the PC may be over the USB 114. The PC 112 may be disconnected from the microcontroller 102 so that the microcontroller 102 may be used as a stand-alone real time data logger, automation and tuning system for the industrial device 222.

For example, “tuning” power data may be written to the SD card or MMC 110 of the microcontroller 102, the microcontroller may function as a data logger by decoding the tuning power data stored in the SD card or MMC 110 and instruct the power control 224, e.g., silicon controlled rectifiers (SCRs), triacs, power relays, etc., to control the power coupled to the industrial device 222 for optimum utilization. Power, therefore, may be used only when needed, and may be used to its fullest capabilities. This results in optimized production and a reduction in both power outages and energy bills.

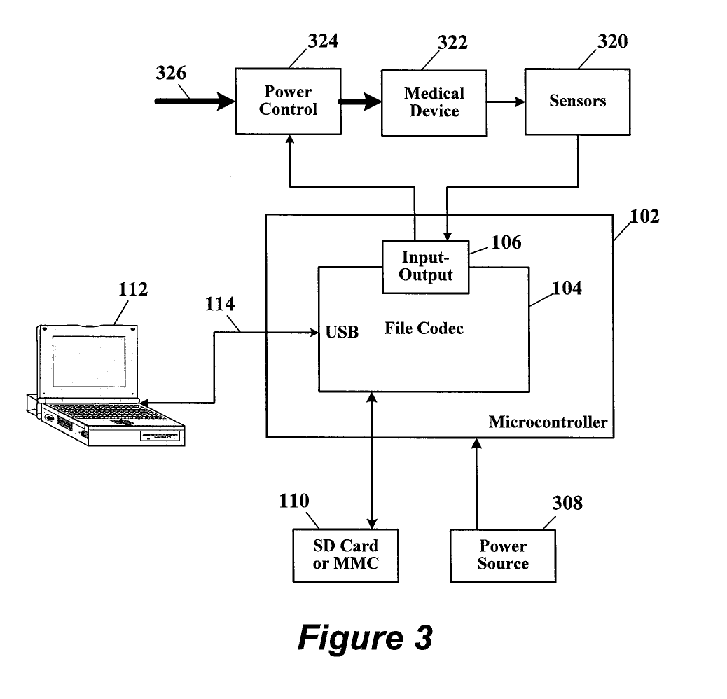

Referring to FIG. 3, depicted is a schematic block diagram of the personal computer and microcontroller of FIG. 1 having input-output and memory storage, and adapted for use as a USB-MSD based real time data logger, automation and tuning system for medical applications, according to another specific example embodiment of this disclosure. The power source 308 may be a battery, power supply, solar cells, fuel cell, etc. A power control 324, e.g., silicon controlled rectifiers (SCRs), triacs, power relays, etc., may be used to control power from a power source 326 to be supplied to a medical device 322. Operation of the medical device 322 may be monitored with sensors 320. The input-output 106 of the microcontroller 102 may be used to control the power control 324 and receive information about medical device 322 from the sensors 320. A time of day clock (not shown) may be used in combination with a load shedding schedule that may be stored in the SD card or MMC 110. Operational profiles for the medical device 322 may also be stored in the SD card or MMC 110. Programming of the microcontroller 102 and/or data transfer between the SD card or MMC 110 and the PC may be over the USB 114. The PC 112 may be disconnected from the microcontroller 102 so that the microcontroller 102 may be used as a stand-alone real time data logger, automation and tuning system for the medical device 322. The medical device 322, e.g., medical centrifuge, may be controlled and monitored by the microcontroller 102. For example, in a medical laboratory, a centrifuge may be started when power rates are lowest and run for a specified time without lab technician oversight.

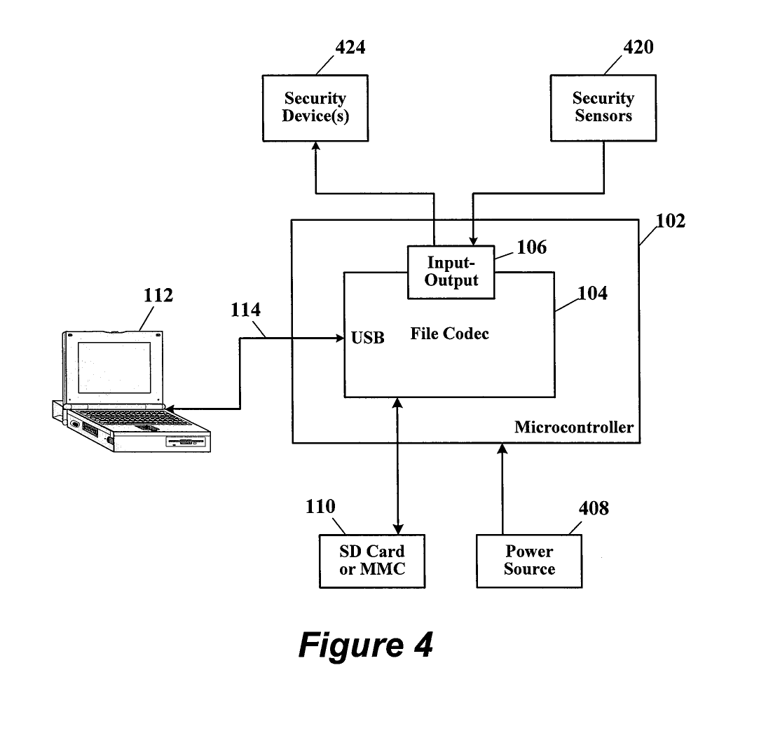

Referring to FIG. 4, depicted is a schematic block diagram of the personal computer and microcontroller of FIG. 1 having input-output and memory storage, and adapted for use as a USB-MSD based real time data logger, automation and tuning system for security applications, according to yet another specific example embodiment of this disclosure. The power source 408 may be a battery, power supply, solar cells, fuel cell, etc. Security device(s) 424, e.g., gates, doors, etc., may be controlled by the microcontroller 102 via the input-output 106. Security sensors 420 may send security information to the input-output 106 of the microcontroller 102. Security access and control profiles, e.g., pass codes, finger printers, etc., may be programmed from the PC 112 to the microcontroller 102 and stored in the SD card or MMC 110. The microcontroller 102 may also send information from the security sensors 420 and status of the security devices 424 to the PC 112 for local monitoring and supervisory override control. The PC 112 may also send security information to other remote monitoring locations via Ethernet and the Internet (not shown).

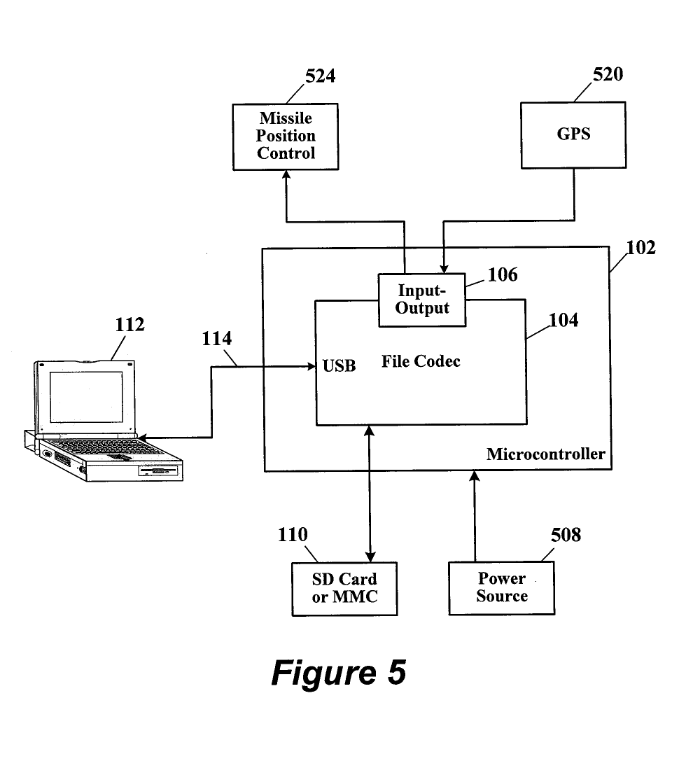

Referring to FIG. 5, depicted is a schematic block diagram of the personal computer and microcontroller of FIG. 1 having input-output and memory storage, and adapted for use as a USB-MSD based real time data logger, automation and tuning system for missile position control applications, according to still another specific example embodiment of this disclosure. The power source 508 may be a battery, solar cells, fuel cell, etc., associated with the missile. A missile (not shown) in flight may be guided by a missile position control 524 that may be coupled to and controlled by the microcontroller 102. Missile flight position may be supplied by a Global Position Satellite (GPS) receiver 520. The missile position control 524 and GPS receiver 520 may be coupled to the input-output 106 of the microcontroller 102. A flight plan may be programmed from the PC or PDA 112 to the microcontroller 102 and stored in the SD card or MMC 110 for use by the microcontroller 102 in guiding the missile (not shown) during flight thereof.

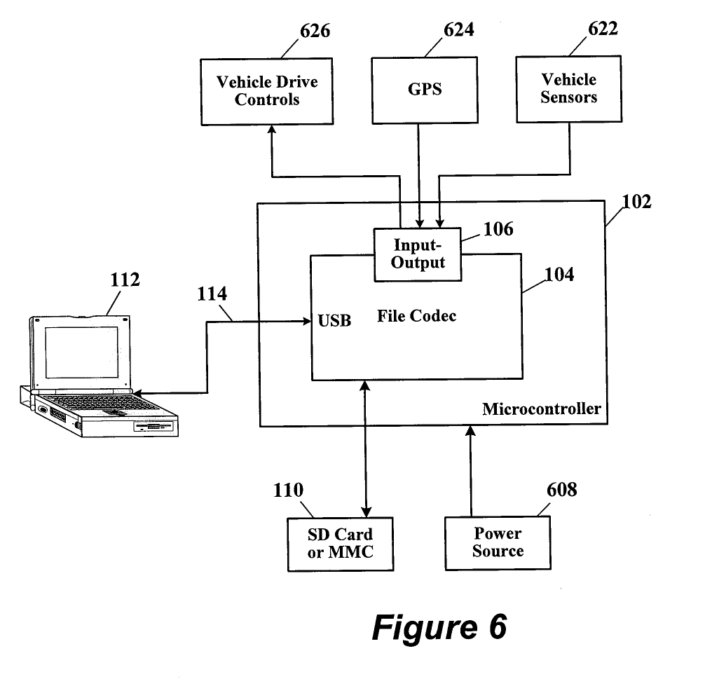

Referring to FIG. 6, depicted is a schematic block diagram of the personal computer and microcontroller of FIG. 1 having input-output and memory storage, and adapted for use as a USB-MSD based real time data logger, automation and tuning system for vehicle control applications, according to another specific example embodiment of this disclosure. The power source 608 may be a car battery, solar cells, fuel cell, etc., associated with a vehicle. The vehicle (not shown) may be guided by vehicle drive controls 626 that may be coupled to and controlled by the microcontroller 102. Vehicle position may be supplied by a Global Position Satellite (GPS) receiver 624. Other pertinent vehicle information, e.g., distance from another vehicle, speed, wheel rotation, engine speed and gear selection, visual information of road condition, etc., may be supplied to the microcontroller 102 from the vehicle sensors 622.

The vehicle drive controls 626 and GPS receiver 622 may be coupled to the input-output 106 of the microcontroller 102. A vehicle driving plan may be programmed from the PC or PDA 112 to the microcontroller 102 and stored in the SD card or MMC 110 for use by the microcontroller 102 in guiding the vehicle (not shown) during travel thereof.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A system for industrial real time data logging, automation and tuning, said system comprising:
a microcontroller having input-output, a file coding and decoding module, a Universal Serial Bus (USB) port, and a non-volatile memory interface;
an industrial device;
power control coupled to a first power source and the industrial device, wherein the power control is coupled to the microcontroller input-output and controlled by the microcontroller;
sensors coupled to the industrial device and the microcontroller input-output, wherein the sensors supply information about the industrial device to the microcontroller;
a non-volatile memory coupled to the non-volatile memory interface of the microcontroller; and
a second power source for powering the microcontroller and non-volatile memory;
wherein a real time data logging, automation and tuning program is stored in the non-volatile memory and controls the microcontroller when the microcontroller is monitoring and controlling operation of the industrial device.

2. The system according to claim 1, further comprising a personal computer (PC) coupled to the USB port of the microcontroller.

3. The system according to claim 2, wherein the PC is used to create the real time data logging, automation and tuning program and transfer of the real time data logging, automation and tuning program to the microcontroller.

4. The system according to claim 1, further comprising a personal digital assistant (PDA) coupled to the USB port of the microcontroller.

5. The system according to claim 4, wherein the PDA is used to create the real time data logging, automation and tuning program and transfer of the real time data logging, automation and tuning program to the microcontroller.

6. The system according to claim 1, wherein the real time data logging, automation and tuning program is stored in the non-volatile memory using a standard data storage format.

7. The system according to claim 6, wherein the standard data storage format is mass storage device (MSD) protocol.

8. The system according to claim 6, wherein the standard data storage format is Serial Peripheral Interface (SPI).

9. The system according to claim 6, wherein the standard data storage format is Secure Digital (SD) bus mode.

10. The system according to claim 1, wherein the non-volatile memory is a Secure Digital (SD) card.

11. The system according to claim 1, wherein the non-volatile memory is a Multimedia Card (MMC).

12. The system according to claim 1, wherein the second power source is selected from the group consisting of battery, power supply, solar cells and fuel cells.

13. A system for medical real time data logging, automation and tuning, said system comprising:
a microcontroller having input-output, a file coding and decoding module, a Universal Serial Bus (USB) port, and a non-volatile memory interface;
a medical device;
power control coupled to a first power source and the medical device, wherein the power control is coupled to the microcontroller input-output and controlled by the microcontroller;
sensors coupled to the medical device and the microcontroller input-output, wherein the sensors supply information about the medical device to the microcontroller;
a non-volatile memory coupled to the non-volatile memory interface of the microcontroller; and
a second power source for powering the microcontroller and non-volatile memory;
wherein a real time data logging, automation and tuning program is stored in the non-volatile memory and controls the microcontroller when the microcontroller is monitoring and controlling operation of the medical device.

14. The system according to claim 13, further comprising a personal computer (PC) coupled to the USB port of the microcontroller.

15. The system according to claim 14, wherein the PC is used to create the real time data logging, automation and tuning program and transfer of the real time data logging, automation and tuning program to the microcontroller.

16. The system according to claim 13, further comprising a personal digital assistant (PDA) coupled to the USB port of the microcontroller.

17. The system according to claim 16, wherein the PDA is used to create the real time data logging, automation and tuning program and transfer of the real time data logging, automation and tuning program to the microcontroller.

18. The system according to claim 13, wherein the real time data logging, automation and tuning program is stored in the non-volatile memory using a standard data storage format.

19. The system according to claim 18, wherein the standard data storage format is mass storage device (MSD) protocol.

20. The system according to claim 18, wherein the standard data storage format is Serial Peripheral Interface (SPI).

21. The system according to claim 18, wherein the standard data storage format is Secure Digital (SD) bus mode.

22. The system according to claim 13, wherein the non-volatile memory is a Secure Digital (SD) card.

23. The system according to claim 13, wherein the non-volatile memory is a Multimedia Card (MMC).

24. The system according to claim 13, wherein the second power source is selected from the group consisting of battery, power supply, solar cells and fuel cells.

25. A system for security real time data logging, automation and tuning, said system comprising:
a microcontroller having input-output, a file coding and decoding module, a Universal Serial Bus (USB) port, and a non-volatile memory interface;
at least one security device coupled to the microcontroller input-output and controlled by the microcontroller;
security sensors coupled to the microcontroller input-output, wherein the sensors supply security information to the microcontroller;
a non-volatile memory coupled to the non-volatile memory interface of the microcontroller; and
a power source for powering the microcontroller and non-volatile memory;
wherein a real time data logging, automation and tuning program is stored in the non-volatile memory and controls the microcontroller when the microcontroller is monitoring and controlling operation of the security device.

26. The system according to claim 25, further comprising a personal computer (PC) coupled to the USB port of the microcontroller.

27. The system according to claim 26, wherein the PC is used to create the real time data logging, automation and tuning program and transfer of the real time data logging, automation and tuning program to the microcontroller.

28. The system according to claim 25, further comprising a personal digital assistant (PDA) coupled to the USB port of the microcontroller.

29. The system according to claim 28, wherein the PDA is used to create the real time data logging, automation and tuning program and transfer of the real time data logging, automation and tuning program to the microcontroller.

30. The system according to claim 25, wherein the real time data logging, automation and tuning program is stored in the non-volatile memory using a standard data storage format.

31. The system according to claim 30, wherein the standard data storage format is mass storage device (MSD) protocol.

32. The system according to claim 30, wherein the standard data storage format is Serial Peripheral Interface (SPI).

33. The system according to claim 30, wherein the standard data storage format is Secure Digital (SD) bus mode.

34. The system according to claim 25, wherein the non-volatile memory is a Secure Digital (SD) card.

35. The system according to claim 25, wherein the non-volatile memory is a Multimedia Card (MMC).

36. The system according to claim 25, wherein the power source is selected from the group consisting of battery, power supply, solar cells and fuel cells.

37. A system for missile real time data logging, automation and tuning, said system comprising:
a microcontroller having input-output, a file coding and decoding module, a Universal Serial Bus (USB) port, and a non-volatile memory interface;
missile position control coupled to the microcontroller input-output and controlled by the microcontroller;
a global position satellite (GPS) receiver coupled to the microcontroller input-output, wherein the GPS receiver supplies information about a position of the GPS receiver to the microcontroller;
a non-volatile memory coupled to the non-volatile memory interface of the microcontroller; and
a power source for powering the microcontroller and non-volatile memory;
wherein a real time data logging, automation and tuning program is stored in the non-volatile memory and controls the microcontroller when the microcontroller is monitoring and controlling operation of the missile position control.

38. The system according to claim 37, further comprising a personal computer (PC) coupled to the USB port of the microcontroller.

39. The system according to claim 38, wherein the PC is used to create the real time data logging, automation and tuning program and transfer of the real time data logging, automation and tuning program to the microcontroller.

40. The system according to claim 37, further comprising a personal digital assistant (PDA) coupled to the USB port of the microcontroller.

41. The system according to claim 40, wherein the PDA is used to create the real time data logging, automation and tuning program and transfer of the real time data logging, automation and tuning program to the microcontroller.

42. The system according to claim 37, wherein the real time data logging, automation and tuning program is stored in the non-volatile memory using a standard data storage format.

43. The system according to claim 42, wherein the standard data storage format is mass storage device (MSD) protocol.

44. The system according to claim 42, wherein the standard data storage format is Serial Peripheral Interface (SPI).

45. The system according to claim 42, wherein the standard data storage format is Secure Digital (SD) bus mode.

46. The system according to claim 37, wherein the non-volatile memory is a Secure Digital (SD) card.

47. The system according to claim 37, wherein the non-volatile memory is a Multimedia Card (MMC).

48. The system according to claim 37, wherein the power source is selected from the group consisting of battery, power supply, solar cells and fuel cells.

49. A system for vehicle real time data logging, automation and tuning, said system comprising:
a microcontroller having input-output, a file coding and decoding module, a Universal Serial Bus (USB) port, and a non-volatile memory interface;
vehicle drive controls coupled to the microcontroller input-output and controlled by the microcontroller, the vehicle controls adapted for controlling a vehicle;
a global position satellite (GPS) receiver coupled to the microcontroller input-output, wherein the GPS receiver supplies information about a position of the GPS receiver to the microcontroller;
vehicle sensors coupled to the microcontroller input-output, wherein the vehicle sensors supply information about operation of the vehicle to the microcontroller;
a non-volatile memory coupled to the non-volatile memory interface of the microcontroller; and
a power source for powering the microcontroller and non-volatile memory;
wherein a real time data logging, automation and tuning program is stored in the non-volatile memory and controls the microcontroller when the microcontroller is monitoring and controlling operation of the vehicle drive controls.

50. The system according to claim 49, further comprising a personal computer (PC) coupled to the USB port of the microcontroller.

51. The system according to claim 50, wherein the PC is used to create the real time data logging, automation and tuning program and transfer of the real time data logging, automation and tuning program to the microcontroller.

52. The system according to claim 49, further comprising a personal digital assistant (PDA) coupled to the USB port of the microcontroller.

53. The system according to claim 52, wherein the PDA is used to create the real time data logging, automation and tuning program and transfer of the real time data logging, automation and tuning program to the microcontroller.

54. The system according to claim 49, wherein the real time data logging, automation and tuning program is stored in the non-volatile memory using a standard data storage format.

55. The system according to claim 54, wherein the standard data storage format is mass storage device (MSD) protocol.

56. The system according to claim 54, wherein the standard data storage format is Serial Peripheral Interface (SPI).

57. The system according to claim 54, wherein the standard data storage format is Secure Digital (SD) bus mode.

58. The system according to claim 49, wherein the non-volatile memory is a Secure Digital (SD) card.

59. The system according to claim 49, wherein the non-volatile memory is a Multimedia Card (MMC).

60. The system according to claim 49, wherein the power source is a vehicle battery.
